(19) United States
(12) Patent Application Publication
(10) Pub. No.: US 2024/0290340 A1
(43) Pub. Date: Aug. 29, 2024

(54) FILTER GENERATION APPARATUS, FILTER GENERATION METHOD, AND PROGRAM

(71) Applicant: NIPPON TELEGRAPH AND TELEPHONE CORPORATION, Tokyo (JP)

(72) Inventors: Rintaro IKESHITA, Tokyo (JP); Keisuke KINOSHITA, Tokyo (JP); Naoyuki KAMO, Tokyo (JP); Tomohiro NAKATANI, Tokyo (JP)

(73) Assignee: NIPPON TELEGRAPH AND TELEPHONE CORPORATION, Tokyo (JP)

(21) Appl. No.: 18/573,932

(22) PCT Filed: Jun. 24, 2021
(86) PCT No.: PCT/JP2021/023945

§ 371 Date: Dec. 22, 2023

(51) Int. Cl. G10L 21/0224; G10L 21/0208

(52) U.S. Cl. CPC G10L 21/0224; G10L 2021/02082

(57) ABSTRACT

Provided is a highly accurate dereverberation technique even under a noise environment or under a poor determination condition. A filter generation device that generates a reverberation prediction filter G[t] used at a time point t from an observation signal x[t] at the time point t, includes a switch determination unit that determines a switch c* according to a predetermined expression, a filter generation unit that sets a reverberation prediction filter G[c*] calculated according to a predetermined expression as the reverberation prediction filter G[t], and a matrix update unit that updates a matrix B[c] according to a predetermined expression.

### TECHNICAL FIELD

The present invention relates to a technique for generating a signal obtained by removing reverberation from a mixed acoustic signal observed by using one or more microphones.

### BACKGROUND ART

An online dereverberation technology for generating a signal (hereinafter, referred to as a dereverberation signal) obtained by sequentially removing reverberation from a mixed acoustic signal (hereinafter, referred to as an observation signal) observed by using one or more microphones is widely used for preprocessing of voice recognition and the like. As an online dereverberation technology, for example, there is an online weighted prediction error (Online WPE) method disclosed in Non Patent Literature 1.

### CITATION LIST

### Non Patent Literature

Non Patent Literature 1: T. Yoshioka and T. Nakatani, “Dereverberation for reverberation-robust microphone arrays,” in Proc. EUSIPCO, pp. 1-5, 2013.

### SUMMARY OF INVENTION

### Technical Problem

However, since the online WPE method uses a simple linear prediction filter as a reverberation prediction filter, there is a problem that the dereverberation performance deteriorates due to a model error, that is, an error caused by an ideal reverberation prediction filter that cannot be expressed in the form of a linear prediction filter under a noise environment or under a poor determination condition in which the number of sound sources is larger than the number of microphones.

Therefore, an object of the present invention is to provide a highly accurate dereverberation technique even under a noise environment or under a poor determination condition.

### Solution to Problem

According to an aspect of the present invention, there is provided a filter generation device that generates a reverberation prediction filter G[t] used at a time point t from an observation signal x[t] at the time point t and observation signals x[1], . . . , and x[t−1] at time points 1, . . . , and t−1 before the time point t, the filter generation device including a filter generation unit that generates the reverberation prediction filter G[t] by using a reverberation prediction filter G[t, c] (where c=1, . . . , and C) and a parameter α[t, c] (where c=1, . . . , and C) with G[t]=Σ_{c=1}^{c}α[t, c]G[t, c], the reverberation prediction filter G[t, c] (where c=1, . . . , and C) and the parameter α[t, c] minimizing a predetermined expression calculated by using the observation signals x[1], . . . , and x[t] and a forgetting weights γₜ[i, 1], . . . , and γₜ[i, C] (where i=1, . . . , and t) at the time point t, C being a parameter indicating the number of reverberation prediction filters, G[i, c] (where c=1, . . . , and C) being a parameter indicating a reverberation prediction filter at the time point i, and α[i, c] (where c=1, . . . , and C) (where α[i, c] ∈ {0, 1}, and Σ_{c=1}^{c}α[i, c]=1) being a parameter indicating a reverberation prediction filter used at the time i,

in which the forgetting weights γₜ[i, 1], . . . , and γₜ[i, C] take greater values as the number of reverberation prediction filters selected as reverberation prediction filters to be applied to an observation signal becomes smaller among the reverberation prediction filters G[i, c], . . . , and G[t, c] (where c=1, . . . , and C) corresponding to the forgetting weight γₜ[i, c] between the time point t and the time point i before time point t by time t-i.

According to an aspect of the present invention, there is provided a filter generation device that generates a reverberation prediction filter G[t] used at a time t from an observation signal x[t] at the time t, the filter generation device including: a switch determination unit, a filter generation unit, and a matrix update unit. The switch determination unit determines a switch c* according to the following expression.

z[t,c]←x[t]−G[c]^{H}\hat{x}[t] [Math. 1]

Here, L is a filter length, Δ is a prediction delay, and \hat{ }x[t]=[x[t−Δ]^{T}, . . . , x[t−Δ−L+1]^{T}]^{T}, C being the number of reverberation prediction filters, G[c] (where c=1, . . . , and C) being a reverberation prediction filter, p being a constant satisfying 0<p≤2, β being a constant satisfying 0<β≤1, and θ being a constant satisfying 0≤θ≤1.

c*←argmin{∥z[t,c]∥2/2|c=1, . . . ,C} [Math. 2]

The filter generation unit sets a reverberation prediction filter G[c*] calculated according to the following expression as the reverberation prediction filter G[t].

$$w [ {c}^{*} ] ← \frac{p}{2} {( {‖ z [ t , {c}^{*} ] ‖}_{2} )}^{- 2 + p} \qquad [ Math . 3 ]$$

$$ψ ← \frac{B [ {c}^{*} ] \hat{x} [ t ]}{1 / w [ {c}^{*} ] + {\hat{x} [ t ]}^{H} B [ {c}^{*} ] \hat{x} [ t ]} \qquad [ Math . 4 ]$$

$$G [ {c}^{*} ] ← G [ {c}^{*} ] + ψ {z [ t , {c}^{*} ]}^{H} \qquad [ Math . 5 ]$$

The matrix update unit updates a matrix B[c] according to the following expression.

$$[ Math . 6 ]$$

$$B [ c ] ← \{ \begin{matrix}\frac{1}{β} ( I - ψ {\hat{x} [ t ]}^{H} ) & B [ c ] ( c = {c}^{*} ) \\ \frac{1}{{β}^{θ}} B [ c ] & ( otherwise )\end{matrix}$$

The filter generation device is configured as described above.

### Advantageous Effects of Invention

According to the present invention, highly accurate dereverberation can be performed even under a noise environment or under a poor determination condition.

### BRIEF DESCRIPTION OF DRAWINGS

FIG. 1 is a block diagram illustrating a configuration of a filter generation device 100.

FIG. 2 is a flowchart illustrating an operation of the filter generation device 100.

FIG. 3 is a block diagram illustrating a configuration of a dereverberation signal generation device 200.

FIG. 4 is a flowchart illustrating an operation of the dereverberation signal generation device 200.

FIG. 5 is a block diagram illustrating a configuration of a filter generation device 300.

FIG. 6 is a flowchart illustrating an operation of the filter generation device 300.

FIG. 7 is a block diagram illustrating a configuration of a dereverberation signal generation device 400.

FIG. 8 is a flowchart illustrating an operation of the dereverberation signal generation device 400.

FIG. 9 is a diagram illustrating an example of a functional configuration of a computer that implements each device according to the embodiment of the present invention.

### DESCRIPTION OF EMBODIMENTS

Hereinafter, embodiments of the present invention will be described in detail. Note that components having the same functions are denoted by the same reference numerals, and redundant description will be omitted.

Prior to the description of each embodiment, a notation method in the present specification will be described.

\hat{ } (caret) represents a superscript. For example, x^{y\hat{ }z} represents that y^{z} is a superscript for x, and x_{y\hat{ }z} represents that y^{z} is a subscript for x. Furthermore, (underscore) represents a subscript. For example, x^{y_z} represents that y_{z} is a superscript for x, and x^{y_z} represents that y_{z} is a subscript for x.

A superscript “\hat{ }” or “˜” such as \hat{ }x or ˜x for a certain letter x would normally be placed directly above “x”, but is written as \hat{ }x or ˜x due to restrictions of notation in the specification.

### TECHNICAL BACKGROUND

First, online switching WPE that is a dereverberation technology used in the embodiments of the present invention will be described.

The online dereverberation problem to be handled in the present invention is a problem of estimating a dereverberation signal z[f, t] at a time point t from an observation signal x[f, t] at the time point t and observation signals x[f, t−1], . . . , and x[f, 1] at the preceding time points t−1, . . . , and 1 when M is the number of microphones and K is the number of sound sources.

$$[ Math . 7 ]$$

$$x [ f , t ] = {\sum }_{τ = 0}^{N} A [ f , τ ] s [ f , t - τ ] + n [ f , t ] ∈ {C}^{M}$$

(Here, f is a parameter representing a frequency bin, t is a parameter representing a time point, s[f, t] ∈C^{K} is acoustic signals from K sound sources, n[f, t] ∈C^{M} is a background noise signal, and (A[f, τ])_{τ=0}^{N} is an acoustic transfer function (where A[f, τ] ∈C^{M×K}, and N is the order of the acoustic transfer function A) from the sound source to the microphone.)

$$[ Math . 8 ]$$

$$z [ f , t ] := A [ f , 0 ] s [ f , t ] + {n}^{′} [ f , t ] ∈ {C}^{M}$$

(Here n′ [f, t] τC^{M} is a background noise signal after dereverberation.)

Hereinafter, since the online dereverberation problem can be handled independently for each frequency bin f, the symbol f representing the frequency bin is omitted.

A model of the online switching WPE, which is a solution to the online dereverberation problem, is defined as a solution to the optimization problem of Expression (1) with p (0<p≤2), β(0<β≤1), and θ (0≤θ≤1) as hyperparameters of the model.

$$[ Math . 9 ]$$

$${minimize}_{G [ t ] , α [ t ]} {\sum }_{i = 1}^{t} {\sum }_{c = 1}^{C} {β}^{{N}_{t} [ i , c ]} α [ i , c ] {‖ {z}_{t} [ i , c ] ‖}_{2}^{p} \qquad ( 1 )$$

(Here C represents the number of reverberation prediction filters, and c represents a parameter indicating a reverberation prediction filter.)

$$[ Math . 10 ]$$

$${z}_{t} [ i , c ] = x [ i ] - {G [ t , c ]}^{H} \hat{x} [ i ] ∈ {C}^{M}$$

$$[ Math . 11 ]$$

$$\hat{x} [ i ] = {[ {x [ i - Δ ]}^{T} , … , {x [ i - Δ - L + 1 ]}^{T} ]}^{T} ∈ {C}^{ML}$$

(Here L represents a filter length and Δ represents a prediction delay.)

$$[ Math . 12 ]$$

$$α [ t , c ] ∈ \{ 0 , 1 \} , {\sum }_{c = 1}^{C} α [ t , c ] = 1$$

$$[ Math . 13 ]$$

$${N}_{t} [ i , c ] = \{ \begin{matrix}0 & ( if i = t ) \\ δ [ i , c ] + … + δ [ t - 1 , c ] & ( if i < t )\end{matrix} \qquad ( 2 )$$

$$[ Math . 14 ]$$

$$δ [ i , c ] = ( 1 - θ ) α [ i , c ] + θ \qquad ( 3 )$$

In Expression (1), βN_t[i,c]α[i,c] represents an adaptive weight of the cost term ∥zₜ[i,c]∥₂P.

Here, G[t]=(G[t, c])_{c=1}^{C} and α[t]=(α[t, c])_{c=1}^{C} are variables of the model at the time point t, that is, parameters to be estimated in the model of the online switching WPE, G [t]=(G [t, c])_{c=1}^{C} represents a reverberation prediction filter at the time point t, and α[t]=(α[t, c])_{c=1}^{C} represents a parameter indicating a reverberation prediction filter used at the time point t.

The hyperparameters p, β, and θ used in the model of the online switching WPE are set in advance, the hyperparameter p is a shape parameter of a generalized normal distribution followed by the dereverberation signal, the hyperparameter β is a forgetting coefficient, and the hyperparameter θ is a parameter for adjusting a forgetting speed of a forgetting weight β^{N_t[i,c]}.

Here, it can be said that, as the number of reverberation prediction filters selected as reverberation prediction filters applied to an observation signal becomes smaller among the reverberation prediction filters G[i, c], . . . , and G[t, c] (where c=1, . . . , and C) corresponding to the forgetting weight β^{N_t[i,c]} between the time point i before the time point t by the time t-i and the time point t, the forgetting weights β^{N_t[i,1]}, . . . , and β^{N_t[i,C]} at the time point t take greater values.

The online switching WPE coincides with the online WPE in Non Patent Literature 1 when C=1.

The online switching WPE has the following two features.

(Feature 1) The online switching WPE generates the dereverberation signal z[f, t] by selecting and using an optimal reverberation prediction filter from among the C reverberation prediction filters at each time point t and each frequency bin f. Consequently, it is possible to reduce a model error under a noise environment or under a poor determination condition, which is a problem in the online WPE, and to improve dereverberation performance.

(Feature 2) The online switching WPE adjusts the forgetting speed of the forgetting weight β^{N_t[i,c]} according to Expressions (2) and (3). Details will be described below. From Expressions (2)′ equivalent to Expression (2) and Expression (3), it can be seen that the forgetting weight β^{N_t[i,c]} (where i=1, . . . , and t−1) is multiplied by β^{δ[t,c]} at time point t and attenuated, and the attenuation rate δ[t, c] is adjusted according to Expression (3).

$$[ Math . 15 ]$$

$${N}_{t + 1} [ i , c ] = {N}_{t} [ i , c ] + δ [ t , c ] \qquad {( 2 )}^{′}$$

For example, when θ=1, δ[t, c]=1, and the forgetting weight β^{N_t[i,c]} related to all the reverberation prediction filters is multiplied by β and attenuated at time point t, so that the attenuation rate is high. For example, when θ=0, δ[t, c]=α[t, c], and a forgetting weight β^{N_t[i,c\hat{ }*]} related to a reverberation prediction filter c* at which α[t, c*]=1 at the time point t is multiplied by β and attenuated, and the forgetting weight β^{N_t[i,c]} related to the other reverberation prediction filter c is not attenuated, so that the attenuation rate is low.

An algorithm for solving the optimization problem (hereinafter, referred to as an optimization algorithm) of Expression (1) will be described. First, the theoretical background of the optimization algorithm will be described. In this optimization algorithm, the parameter α[t] and the reverberation prediction filter G[t] are alternately updated.

(1) Calculation of Parameter α[t]

α[t, c] (where c=1, . . . , and C) is calculated according to the following expression.

$$[ Math . 16 ]$$

$$α [ t , c ] = \{ \begin{matrix}1 & ( if c = arg {min}_{c} {‖ {z}_{t} [ t , c ] ‖}_{2}^{2} ) \\ 0 & ( otherwise )\end{matrix}$$

α[t, c*]=1 is established for c satisfying c=argmin_{c}∥zₜ[t] ∥₂² with respect to the switch c*.

### (2) Calculation of Reverberation Prediction Filter G[t]

First, wₜ[t, c] (where c=1, . . . , and C) is calculated.

$$[ Math . 17 ]$$

$${w}_{t} [ i , c ] ← \frac{p}{2} {( {‖ {z}_{t} [ i , c ] ‖}_{2} )}^{- 2 + p} \qquad ( 4 )$$

Next, G[t, c] (where c=1, . . . , and C) is calculated. G[t, c] satisfies Expression (5).

$$[ Math . 18 ]$$

$$G [ t , c ] ∈ {minimize}_{G [ t , c ]} {\sum }_{i = 1}^{t} {β}^{{N}_{t} [ i , c ]} α [ i , c ] {w}_{t} [ i , c ] {‖ {z}_{t} [ i , c ] ‖}_{2}^{2} \qquad ( 5 )$$

G[t, c] (where c=1, . . . , and C) satisfying Expression (5) is obtained as follows.

$$[ Math . 19 ]$$

$$G [ t , c ] = {R [ t , c ]}^{- 1} P [ t , c ] \qquad ( 6 )$$

$$[ Math . 20 ]$$

$$R [ t , c ] = {\sum }_{i = 1}^{t} {β}^{{N}_{t} [ i , c ]} α [ i , c ] {w}_{t} [ i , c ] \hat{x} [ i ] {\hat{x} [ i ]}^{H} \qquad ( 7 )$$

$$[ Math . 21 ]$$

$$P [ t , c ] = {\sum }_{i = 1}^{t} {β}^{{N}_{t} [ i , c ]} α [ i , c ] {w}_{t} [ i , c ] \hat{x} [ i ] {x [ i ]}^{H} \qquad ( 8 )$$

However, it takes time to calculate G[t, c] by using Expressions (6), (7), and (8). Therefore, assuming that wₜ[i,c]=wᵢ[i,c] (where i=1, . . . , and t−1, and c=1, . . . , and C), Expressions (7)′ and (8)′ are obtained from Expressions (7) and (8).

$$[ Math . 22 ]$$

$$R [ t , c ] = {β}^{δ [ t - 1 , c ]} R [ t - 1 , c ] + α [ t , c ] {w}_{t} [ t , c ] \hat{x} [ t ] {\hat{x} [ t ]}^{H} \qquad {( 7 )}^{′}$$

$$[ Math . 23 ]$$

$$P [ t , c ] = {β}^{δ [ t - 1 , c ]} P [ t - 1 , c ] + α [ t , c ] {w}_{t} [ t , c ] \hat{x} [ t ] {x [ t ]}^{H} \qquad {( 8 )}^{′}$$

Instead of using Expressions (6), (7), and (8), G[t, c] is calculated by using Expressions (6), (7)′, and (8)′.

A matrix B[t, c] (where c=1, . . . , and C) (where B[t, c]=(β^{δ[t,c]}R[t, c])⁻¹) is considered. Here, when α[t, c]=0, Expressions (9) and (10) are obtained from Expressions (7)′ and (8)′.

$$[ Math . 24 ]$$

$$B [ t , c ] = \frac{1}{{β}^{θ}} B [ t - 1 , c ] \qquad ( 9 )$$

$$[ Math . 25 ]$$

$$G [ t , c ] = G [ t - 1 , c ] \qquad ( 10 )$$

When α[t, c]=1, Expression (11) is obtained from Expression (7)′.

$$[ Math . 26 ]$$

$$\frac{1}{β} {B [ t , c ]}^{- 1} = {B [ t - 1 , c ]}^{- 1} + {w}_{t} [ t , c ] \hat{x} [ t ] {\hat{x} [ t ]}^{H} \qquad ( 11 )$$

From these Expressions, the following Expressions serving as the theoretical background of the optimization algorithm are derived.

$$[ Math . 27 ]$$

$$ψ [ t , c ] ← \frac{B [ t - 1 , c ] \hat{x} [ t ]}{1 / {w}_{t} [ t , c ] + {\hat{x} [ t ]}^{H} B [ t - 1 , c ] \hat{x} [ t ]} \qquad ( 12 )$$

$$[ Math . 28 ]$$

$$B [ t , c ] ← \frac{1}{β} ( I - ψ [ t , c ] {\hat{x} [ t ]}^{H} ) B [ t - 1 , c ] \qquad ( 13 )$$

$$[ Math . 29 ]$$

$$G [ t , c ] ← G [ t - 1 , c ] + ψ [ t , c ] {{z}_{t - 1} [ t , c ]}^{H} \qquad ( 14 )$$

An optimization algorithm based on Expressions (12), (13), and (14) is shown below. This algorithm is called a recursive least square (RLS) algorithm.

### [Optimization Algorithm]

Input: observation signals x[1], . . . , and x[T] ∈C^{M}

Output: dereverberation signals z[1], . . . , and z[T]∈C^{M}

### (1) Initialization

The hyperparameters p, β, and θ are set. Here, it is assumed that the hyperparameters p, β, and θ respectively satisfy 0<p≤2, 0<β≤1, and 0≤θ≤1.

An initial value of the parameter t is set. That is, t is set to 1.

An initial value of the reverberation prediction filter G[c] (where c=1, . . . , and C) is set. For example, an initial value of G[c] (where c=1, . . . , and C) is set as a zero matrix. That is, G[c] is set to O.

An initial value of the matrix B[c] (where c=1, . . . , and C) is set. For example, an initial value of B[c] (where c=1, . . . , and C) is set as an identity matrix. That is, B[c] is set to I.

### (2) Determination of Switch c*

First, z[t, c] (where c=1, . . . , and C) is calculated according to the following expression.

z[t,c]←x[t]−G[c]^{H}\hat{x}[t] [Math. 30]

(Here L is a filter length, Δ is a prediction delay, and \hat{ }x[t]=[x[t−Δ]^{T}, . . . , x[t−Δ−L+1]^{T}]^{T}.)

Next, the switch c* is determined according to the following expression.

c*←argmin{∥z[t,c]∥2/2|c=1, . . . ,C} [Math. 31]

### (3) Calculation of Reverberation Prediction Filter G[c*]

First, w[c*] is calculated according to the following expression.

$$w [ {c}^{*} ] ← \frac{p}{2} {( {‖ z [ t , {c}^{*} ] ‖}_{2} )}^{- 2 + p} \qquad [ Math . 32 ]$$

Next, a reverberation prediction filter G[c*] is calculated according to the following expression.

$$ψ ← \frac{B [ {c}^{*} ] \hat{x} [ t ]}{1 / w [ {c}^{*} ] + {\hat{x} [ t ]}^{H} B [ {c}^{*} ] \hat{x} [ t ]} \qquad [ Math . 33 ]$$

$$G [ {c}^{*} ] ← G [ {c}^{*} ] + ψ {z [ t , {c}^{*} ]}^{H} \qquad [ Math . 34 ]$$

(4) Generation of Dereverberation Signal z[t]

The dereverberation signal z[t] is calculated according to the following expression.

z[t,c]←x[t]-G[c*]^{H}\hat{x}[t] [Math. 35]

### (5) Update of Matrix B[c]

The matrix B[c*] is updated according to the following Expression.

$$B [ {c}^{*} ] ← \frac{1}{β} ( I - ψ {\hat{x} [ t ]}^{H} ) B [ {c}^{*} ] \qquad [ Math . 36 ]$$

The matrix B[c] (where c≠c*) is updated according to the following expression.

$$B [ c ] ← \frac{1}{{β}^{θ}} B [ c ] \qquad [ Math . 37 ]$$

### (6) Update of Parameter t

t is set to t+1.

### (7) Determination of End Condition

In a case where an end condition is satisfied, that is, t>T, the processing is ended, and in other cases, the processing returns to the process (2).

### First Embodiment

For t=1, . . . , and T, the filter generation device 100 generates the reverberation prediction filter G[t] used at the time point t from the observation signal x[t] at the time point t and the observation signals x[1], . . . , and x[t-1] at the time points 1, . . . , and t−1 before the time point t. Here, the observation signal is a mixed acoustic signal from K sound sources observed by using M microphones (where K and M are integers of 1 or greater). The observation signal x[t] at the time point t is an observation signal for a certain frequency bin at the time point t. C is a parameter indicating the number of reverberation prediction filters, G[i, c] (where c=1, . . . , and C) is a parameter indicating a reverberation prediction filter at the time i, and α[i, c] (where c=1, . . . , and C) (where α[i, c] ∈ {0, 1} and Σ_{c=1}^{c}α[i, c]=1 are satisfied) is a parameter indicating the reverberation prediction filter used at the time i.

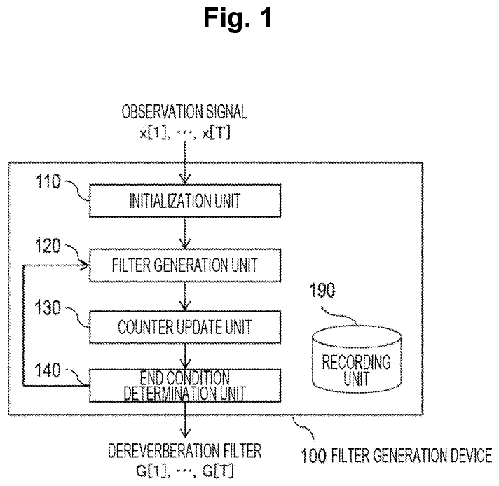

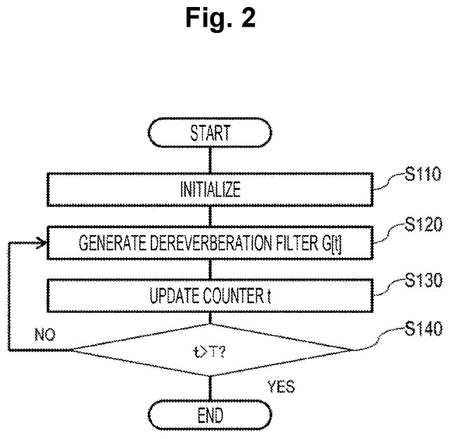

Hereinafter, the filter generation device 100 will be described with reference to FIGS. 1 and 2. FIG. 1 is a block diagram illustrating a configuration of a filter generation device 100. FIG. 2 is a flowchart illustrating an operation of the filter generation device 100. As illustrated in FIG. 1, the filter generation device 100 includes an initialization unit 110, a filter generation unit 120, a counter update unit 130, an end condition determination unit 140, and a recording unit 190. The recording unit 190 is a configuration unit that appropriately records information necessary for processing of the filter generation device 100.

An operation of the filter generation device 100 will be described with reference to FIG. 2.

In S110, the initialization unit 110 sets an initial value of a parameter. Specifically, the initialization unit 110 sets an initial value of the parameter t. That is, the initialization unit 310 sets t to 1.

In S120, the filter generation unit 120 receives input of the observation signals x[1], . . . , and x[t], and generates and outputs the reverberation prediction filter G[t] from G[t]=Σ_{c=1}^{c}α[t, c]G[t, c] by using the reverberation prediction filter G[t, c] (where c=1, . . . , and C) and a parameter α[t, c] (where c=1, . . . , and C) that minimize a predetermined expression calculated by using the observation signals x[1], . . . , and x[t] and the forgetting weights γₜ[i, 1], . . . , and γₜ[i, C] (where i=1, . . . , and t) at the time point t. The predetermined expression is the following expression in which p is a constant satisfying 0<p≤2, β is a constant satisfying 0<β≤1, and θ is a constant satisfying 0≤θ≤1.

$${\sum }_{i = 1}^{t} {\sum }_{c = 1}^{C} {γ}_{t} [ i , c ] α [ i , c ] {‖ {z}_{t} [ i , c ] ‖}_{2}^{p} \qquad [ Math . 38 ]$$

(Here zₜ[i, c] is as follows.)

$${z}_{t} [ i , c ] = x [ i ] - {G [ t , c ]}^{H} \hat{x} [ i ] \qquad [ Math . 39 ]$$

(Here L is a filter length, Δ is a prediction delay, and \hat{ }x[t]=[x[t−Δ]^{T}, . . . , x[t−Δ−L+1]^{T}]^{T}).) In addition, the forgetting weight γₜ[i, c] is calculated as follows.

$${γ}_{t} [ i , c ] = {β}^{{N}_{t} [ i , c ]} \qquad [ Math . 40 ]$$

$${N}_{t} [ i , c ] = \{ \begin{matrix}0 & ( if i = t ) \\ δ [ i , c ] + … + δ [ t - 1 , c ] & ( if i < t )\end{matrix} \qquad [ Math . 41 ]$$

$$δ [ i , c ] = ( 1 - θ ) α [ i , c ] + θ \qquad [ Math . 42 ]$$

As described above, the forgetting weight is calculated.

Therefore, the forgetting weights γₜ[i, 1], . . . , and γₜ[i, C] take greater values as the number of reverberation prediction filters selected as reverberation prediction filters to be applied to the observation signal becomes smaller among the reverberation prediction filters G[i, c], . . . , and G[t, c] (where c=1, . . . , and C) corresponding to the forgetting weight γₜ[i, c] between the time point t and the time point i before time point t by time t-i.

In S130, the counter update unit 130 increments the counter t by 1, that is, the counter update unit 130 sets t to t+1.

In S140, in a case where the counter t has reached a predetermined constant (that is, in a case where the counter t satisfies t>T), the end condition determination unit 140 outputs the reverberation prediction filter G[t](where t=1, . . . , and T) and ends the processing. In other cases, the processing returns to S120, and the processes in S120 to S140 are repeatedly performed. The reverberation prediction filter G[t] (where t=1, . . . , and T) may be output from the filter generation device 100 each time the reverberation prediction filter G[t] is generated in S120.

According to the embodiment of the present invention, it is possible to generate a reverberation prediction filter that enables highly accurate dereverberation even under a noise environment or under a poor determination condition.

### Second Embodiment

A dereverberation signal generation device 200 generates a dereverberation signal from an observation signal by using the reverberation prediction filter generated by the filter generation device 100. That is, for t=1, . . . , and T, the dereverberation signal generation device 200 generates the dereverberation signal z[t] at the time point t from the observation signal x[t] at the time point t and the observation signals x[1], . . . , and x[t−1] at the time points 1, . . . , and t−1 before the time point t.

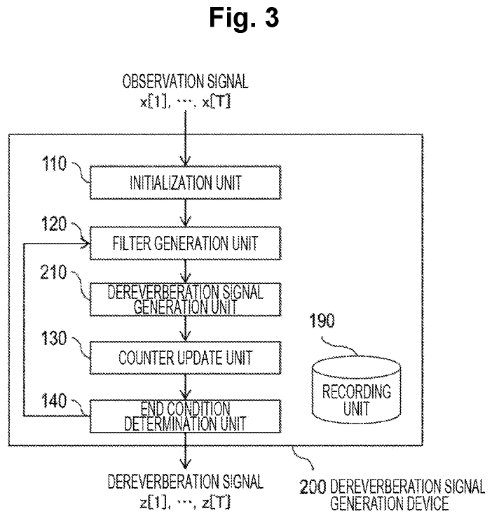

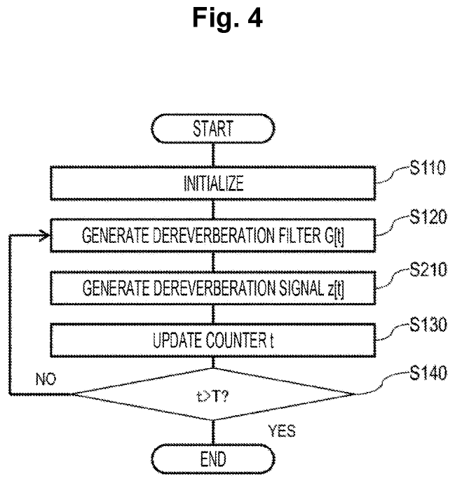

Hereinafter, the dereverberation signal generation device 200 will be described with reference to FIGS. 3 and 4. FIG. 3 is a block diagram illustrating a configuration of the dereverberation signal generation device 200. FIG. 4 is a flowchart illustrating an operation of the dereverberation signal generation device 200. As illustrated in FIG. 3, the dereverberation signal generation device 200 includes an initialization unit 110, a filter generation unit 120, a dereverberation signal generation unit 210, a counter update unit 130, an end condition determination unit 140, and a recording unit 190. The recording unit 190 is a configuration unit that appropriately records information necessary for processing of the dereverberation signal generation device 200. That is, the dereverberation signal generation device 200 is different from the filter generation device 100 only in that the dereverberation signal generation unit 210 is further included.

An operation of the dereverberation signal generation device 200 will be described with reference to FIG. 4. Here, only the operation of the dereverberation signal generation unit 210 will be described.

In S210, the dereverberation signal generation unit 210 uses the observation signal x[t] and the reverberation prediction filter G[t] generated in S120 as inputs, and generates and outputs the dereverberation signal z[t] at the time point t from z[t]=G[t]x[t].

The end condition determination unit 140 outputs the dereverberation signal z[t] (where t=1, . . . , and T) instead of outputting the reverberation prediction filter G[t] (where t=1, . . . , and T). The dereverberation signal z[t] (where t=1, . . . , and T) may be output from the dereverberation signal generation device 200 each time the dereverberation signal z[t] is generated in S210.

According to the embodiment of the present invention, it is possible to generate a highly accurate dereverberation signal even under a noise environment or under a poor determination condition.

### Third Embodiment

A filter generation device 300 generates the reverberation prediction filter G[t] used at the time point t from the observation signal x[t] at the time point t for t=1, . . . , and T. Here, the observation signal is a mixed acoustic signal from K sound sources observed by using M microphones (where K and M are integers of 1 or greater). The observation signal x[t] at the time point t is an observation signal for a certain frequency bin at the time point t. C is the number of reverberation prediction filters, and G[c] (where c=1, . . . , and C) is the reverberation prediction filter.

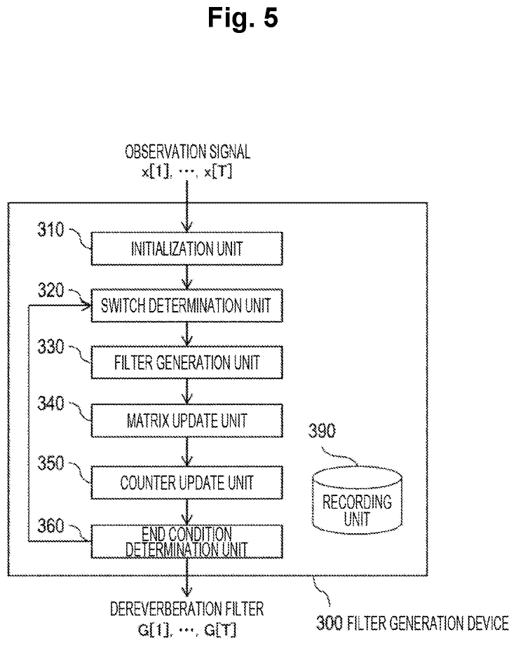

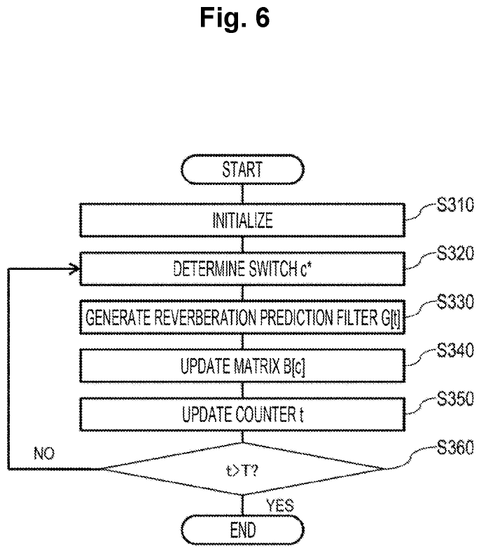

Hereinafter, the filter generation device 300 will be described with reference to FIGS. 5 and 6. FIG. 5 is a block diagram illustrating a configuration of the filter generation device 300. FIG. 6 is a flowchart illustrating an operation of the filter generation device 300. As illustrated in FIG. 5, the filter generation device 300 includes an initialization unit 310, a switch determination unit 320, a filter generation unit 330, a matrix update unit 340, a counter update unit 350, an end condition determination unit 360, and a recording unit 390. The recording unit 390 is a configuration unit that appropriately records information necessary for processing of the filter generation device 300.

An operation of the filter generation device 300 will be described with reference to FIG. 6.

In S310, the initialization unit 310 sets a hyperparameter and an initial value of a parameter. Specifically, the initialization unit 310 sets hyperparameters p, β, and θ (where the hyperparameters p, β, and θ respectively satisfy 0<p≤2, 0<β≤1, and 0≤θ≤1). The initialization unit 310 sets an initial value of the parameter t. That is, the initialization unit 310 sets t to 1. The initialization unit 310 sets an initial value of the reverberation prediction filter G[c] (where c=1, . . . , and C). That is, the initialization unit 310 sets G[c] to O. The initialization unit 310 sets an initial value of the matrix B[c] (where c=1, . . . , and C). That is, the initialization unit 310 sets B[c] to I.

In S320, the switch determination unit 320 determines and outputs the switch c* according to the following expression.

z[t,c]←x[t]−G[c]^{H}\hat{x}[t] [Math. 43]

(where L is a filter length, Δ is a prediction delay, and \hat{ }x[t]=[x[t−Δ]^{T}, . . . , x[t−Δ−L+1]^{T}]^{T})

c*←argmin{∥z[t,c]∥2/2|c=1, . . . ,C} [Math. 44]

In S330, the filter generation unit 330 outputs the reverberation prediction filter G[c*] calculated according to the following expression as the reverberation prediction filter G[t].

$$w [ {c}^{*} ] ← \frac{p}{2} {( {‖ z [ t , {c}^{*} ] ‖}_{2} )}^{- 2 + p} \qquad [ Math . 45 ]$$

$$ψ ← \frac{B [ {c}^{*} ] \hat{x} [ t ]}{1 / w [ {c}^{*} ] + {\hat{x} [ t ]}^{H} B [ {c}^{*} ] \hat{x} [ t ]} \qquad [ Math . 46 ]$$

$$G [ {c}^{*} ] ← G [ {c}^{*} ] + ψ {z [ t , {c}^{*} ]}^{H} \qquad [ Math . 47 ]$$

In S340, the matrix update unit 340 updates and outputs the matrix B[c] according to the following expression.

$$B [ c ] ← \{ \begin{matrix}\frac{1}{β} ( I - ψ {\hat{x} [ t ]}^{H} ) & B [ c ] ( c = {c}^{*} ) \\ \frac{1}{{β}^{θ}} B [ c ] & ( otherwise )\end{matrix} \qquad [ Math . 48 ]$$

In S350, the counter update unit 350 increments the counter t by 1, that is, the counter update unit 350 sets t to t+1.

In S360, in a case where the counter t has reached a predetermined constant (that is, in a case where the counter t satisfies t>T), the end condition determination unit 360 outputs the reverberation prediction filter G[t] (where t=1, . . . , and T) and ends the processing. In other cases, the processing returns to S320, and the processes in S320 to S360 are repeatedly performed. The reverberation prediction filter G[t] (where t=1, . . . , and T) may be output from the filter generation device 300 each time the reverberation prediction filter G[t] is generated in S330.

According to the embodiment of the present invention, it is possible to generate a reverberation prediction filter that enables highly accurate dereverberation even under a noise environment or under a poor determination condition.

### Fourth Embodiment

A dereverberation signal generation device 400 generates a dereverberation signal from an observation signal by using a reverberation prediction filter generated by the filter generation device 300. That is, the dereverberation signal generation device 400 generates the dereverberation signal z[t] at the time point t from the observation signal x[t] at the time point t for t=1, . . . , and T.

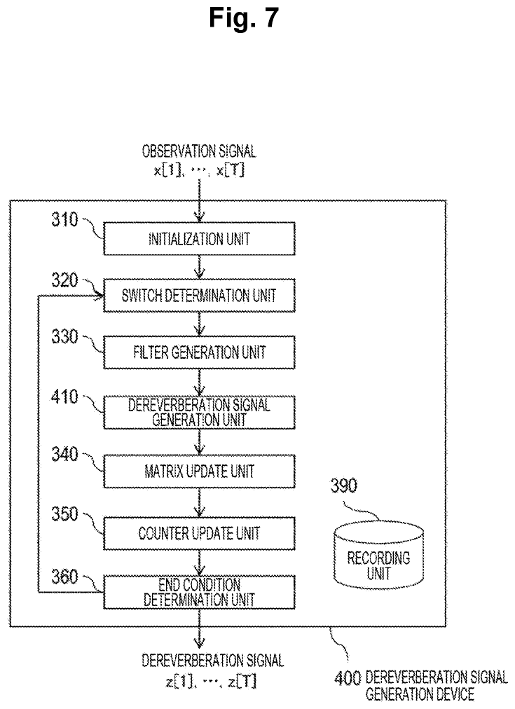

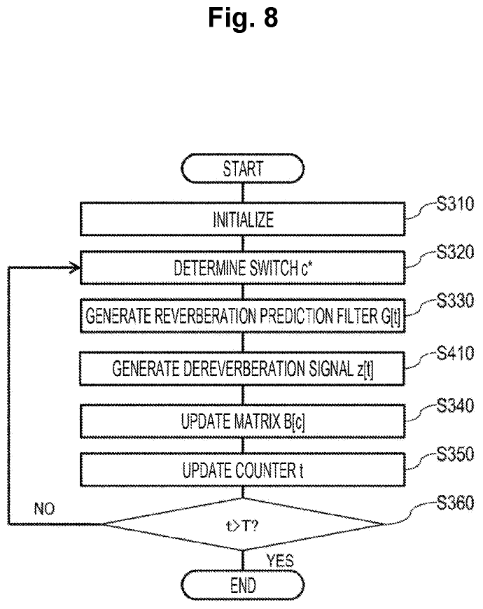

Hereinafter, the dereverberation signal generation device 400 will be described with reference to FIGS. 7 and 8. FIG. 7 is a block diagram illustrating a configuration of the dereverberation signal generation device 400. FIG. 8 is a flowchart illustrating an operation of the dereverberation signal generation device 400. As illustrated in FIG. 7, the dereverberation signal generation device 400 includes an initialization unit 310, a switch determination unit 320, a filter generation unit 330, a dereverberation signal generation unit 410, a matrix update unit 340, a counter update unit 350, an end condition determination unit 360, and a recording unit 390. The recording unit 390 is a configuration unit that appropriately records information necessary for processing of the dereverberation signal generation device 400. That is, the dereverberation signal generation device 400 is different from the filter generation device 300 only in that the dereverberation signal generation unit 410 is further included.

An operation of the dereverberation signal generation device 400 will be described with reference to FIG. 8. Here, only the operation of the dereverberation signal generation unit 410 will be described.

In S410, the dereverberation signal generation unit 410 generates and outputs the dereverberation signal z[t] at the time point t from z[t]=G[t]x[t] by using the observation signal x[t] and the reverberation prediction filter G[t] generated in S330.

The end condition determination unit 360 outputs the dereverberation signal z[t] (where t=1, . . . , and T) instead of outputting the reverberation prediction filter G[t] (where t=1, . . . , and T). The dereverberation signal z[t] (where t=1, . . . , and T) may be output from the dereverberation signal generation device 400 each time the dereverberation signal z[t] is generated in S410.

According to the embodiment of the present invention, it is possible to generate a highly accurate dereverberation signal even under a noise environment or under a poor determination condition.

### <Supplement>

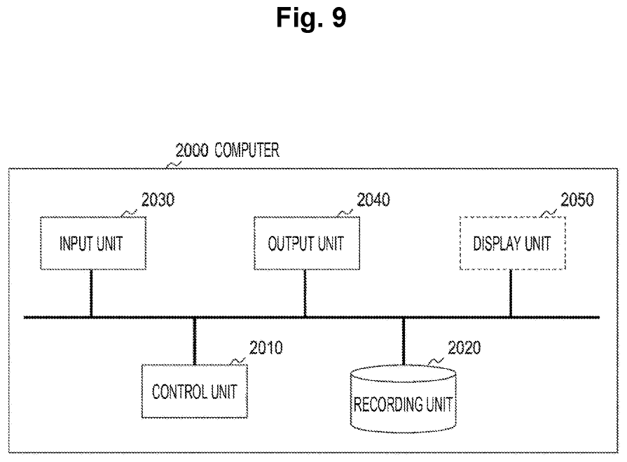

FIG. 9 is a diagram illustrating an example of a functional configuration of a computer 2000 that implements each device described above. Processing in each device described above can be performed by a recording unit 2020 reading a program for causing the computer 2000 to function as each device described above and operate as a control unit 2010, an input unit 2030, an output unit 2040, and the like.

A device according to the present invention includes, for example, an input unit to which a keyboard or the like is connectable as a single hardware entity, an output unit to which a liquid crystal display or the like is connectable, a communication unit to which a communication device (for example, a communication cable) capable of communicating with the outside of the hardware entity is connectable, a central processing unit (CPU in which a cache memory, a register, or the like may be included), a RAM or a ROM that is a memory, an external storage device that is a hard disk, and a bus that connects the input unit, the output unit, the communication unit, the CPU, the RAM, the ROM, and the external storage device such that data can be exchanged therebetween. A device (drive) or the like that can read and write data from and to a recording medium such as a CD-ROM may be provided in the hardware entity as necessary. Examples of a physical entity including such a hardware resource include a general-purpose computer.

The external storage device of the hardware entity stores a program that is required for realizing the above-described functions, data that is required for processing of the program, and the like (the program may be stored, for example, in a ROM that is a read-only storage device instead of the external storage device). Data or the like obtained through processing of the program is stored as appropriate in a RAM, an external storage device, or the like.

In the hardware entity, each program stored in the external storage device (or a ROM or the like) and data required for processing of each program are read into a memory as necessary and are analyzed and processed as appropriate by the CPU. As a result, the CPU realizes a predetermined function (each configuration unit represented as . . . unit, . . . means, or the like).

The present invention is not limited to the above-described embodiment and can be modified as appropriate without departing from the concept of the present invention. The processing described in the above embodiment may be executed not only in time-series according to the described order, but also in parallel or individually according to the processing capability of a device that executes the processing or as necessary.

As described above, in a case where the processing function of the hardware entity (the device according to the present invention) described in the above embodiment is realized by a computer, processing content of the function of the hardware entity is described by a program. The computer executes the program, and thus, the processing function of the hardware entity is realized on the computer.

The program describing the content of the processing may be recorded in a computer-readable recording medium. The computer-readable recording medium may be, for example, any recording medium such as a magnetic recording device, an optical disc, a magneto-optical recording medium, or a semiconductor memory. Specifically, for example, a hard disk device, a flexible disk, or a magnetic tape may be used as the magnetic recording device, a digital versatile disc (DVD), a DVD random access memory (DVD-RAM), a compact disc read only memory (CD-ROM), or a CD recordable/rewritable (CD-R/RW) may be used as the optical disc, a magneto-optical disc (MO) may be used as the magneto-optical recording medium, and an electronically erasable and programmable-read only memory (EEP-ROM) may be used as the semiconductor memory.

The program is distributed, for example, by selling, transferring, or lending a portable recording medium such as a DVD or a CD-ROM on which the program is recorded. The program may be stored in a storage device of a server computer and be distributed by transferring the program from a server computer to another computer via a network.

For example, the computer that executes such a program first temporarily stores the program recorded in the portable recording medium or the program transferred from the server computer in a storage device of the computer. At the time of execution of the processing, the computer then reads the program stored in the storage device of the computer, and executes processing in accordance with the read program. In other execution modes of the program, the computer may read the program directly from the portable recording medium and execute processing in accordance with the program, or alternatively, the computer may sequentially execute processing in accordance with the received program every time the program is transferred from the server computer to the computer. The above processing may be executed by a so-called application service provider (ASP) service that realizes a processing function only by issuing an instruction to execute the program and acquiring a result, without transferring the program from the server computer to the computer. The program in the present embodiments includes information used for processing of the computer and equivalent to the program (for example, data that is not a direct command to the computer but has a property of defining processing of the computer).

Although the hardware entity is configured by executing a predetermined program on a computer in this mode, at least some of the processing content may be realized by hardware.

The description of the embodiment of the present invention described above has been presented for purposes of illustration and description. There is no intention to be comprehensive or to limit the invention to the disclosed precise form. Modifications and variations can be made from the above instructions. The embodiment has been selected and represented in order to provide the best illustration of the principles of the present invention and to enable those skilled in the art to utilize the present invention in various embodiments with various modifications added such that the present invention is appropriate for considered practical use. All such modifications and variations are within the scope of the present invention as defined by the appended claims, interpreted in accordance with a fairly and legally equitable breadth.

1. A filter generation device comprising a processor configured to execute operations comprising:
generating a reverberation prediction filter G[t] used at a time point t from an observation signal x[t] at the time point t and observation signals x[1], . . . , and x[t−1] at time points 1, . . . , and t−1 before the time point t,
wherein the generating uses a reverberation prediction filter G[t, c] (where c=1, . . . , and C) and a parameter α[t, c] (where c=1, . . . , and C) with G[t]=Σ_{c=1}^{c}α[t, c]G[t, c],
the reverberation prediction filter G[t, c] (where c=1, . . . , and C) and the parameter α[t, c] minimizing a predetermined expression calculated by using the observation signals x[1], . . . , and x[t] and a forgetting weights γₜ[i, 1], . . . , and γₜ[i, C] (where i=1, . . . , and t) at the time point t,
C being a parameter indicating the number of reverberation prediction filters, G[i, c](where c=1, . . . , and C) being a parameter indicating a reverberation prediction filter at the time point i,
α[i, c] (where c=1, . . . , and C) (where α[i, c] ∈{0, 1}, and Σ_{c=1}^{c}α[i, c]=1) being a parameter indicating a reverberation prediction filter used at the time i, and
the forgetting weights γₜ[i, 1], . . . , and γₜ[i, C] take greater values as the number of reverberation prediction filters selected as reverberation prediction filters to be applied to an observation signal becomes smaller among the reverberation prediction filters G[i, c], . . . , and G[t, c] (where c=1, . . . , and C) corresponding to the forgetting weight γₜ[i, c] between the time point t and the time point i before time point t by time t-i.

2. The filter generation device according to claim 1, wherein
p is a constant satisfying 0<p≤2, β is a constant satisfying 0<β<1, and θ is a constant satisfying 0≤θ≤1,
the predetermined expression is
$${\sum }_{i = 1}^{t} {\sum }_{c = 1}^{C} {γ}_{t} [ i , c ] α [ i , c ] {‖ {z}_{t} [ i , c ] ‖}_{2}^{p} \qquad [ Math . 49 ]$$
$$( where$$
$${z}_{t} [ i , c ] = x [ i ] - {G [ t , c ]}^{H} \hat{x} [ i ] ) \qquad [ Math . 50 ]$$
(where L is a filter length, Δ is a prediction delay, and \hat{ }x[t]=[x[t−Δ]^{T}, . . . , x[t−Δ-L+1]^{T}]^{T}), and
the forgetting weight γₜ[i, c] is expressed as follows:
$${γ}_{t} [ i , c ] = {β}^{{N}_{t} [ i , c ]} \qquad [ Math . 51 ]$$
$${N}_{t} [ i , c ] = \{ \begin{matrix}0 & ( if i = t ) \\ δ [ i , c ] + … + δ [ t - 1 , c ] & ( if i < t )\end{matrix} \qquad [ Math . 52 ]$$
$$δ [ i , c ] = ( 1 - θ ) α [ i , c ] + θ . \qquad [ Math . 53 ]$$

3. A filter generation device that generates a reverberation prediction filter G[t] used at a time point t from an observation signal x[t] at the time point t, the filter generation device comprising a processor configure execute operations comprising:
determining a switch c* according to the following expression:
z[t,c]←x[t]−G[c]^{H}\hat{x}[t] [Math. 54]
(where L is a filter length, Δ is a prediction delay, and \hat{ }x[t]=[x[t−Δ]^{T}, . . . , x[t−Δ-L+1]^{T}]^{T}), C being the number of reverberation prediction filters, G[c] (where c=1, . . . , and C) being a reverberation prediction filter, p being a constant satisfying 0<p≤2, β being a constant satisfying 0<β≤1, and θ being a constant satisfying 0≤θ≤1, and
c*←argmin{∥z[t,c]∥2/2|c=1, . . . ,C} [Math. 55]
setting a reverberation prediction filter G[c*] calculated according to the following expression as the reverberation prediction filter G[t]:
$$w [ {c}^{*} ] ← \frac{p}{2} {( {‖ z [ t , {c}^{*} ] ‖}_{2} )}^{- 2 + p} \qquad [ Math . 56 ]$$
$$ψ ← \frac{B [ {c}^{*} ] \hat{x} [ t ]}{1 / w [ {c}^{*} ] + {\hat{x} [ t ]}^{H} B [ {c}^{*} ] \hat{x} [ t ]} \qquad [ Math . 57 ]$$
$$G [ {c}^{*} ] ← G [ {c}^{*} ] + ψ {z [ t , {c}^{*} ]}^{H} ; \qquad [ Math . 58 ]$$
and
updating a matrix B[c] according to the following expression:
$$B [ c ] ← \{ \begin{matrix}\frac{1}{β} ( I - ψ {\hat{x} [ t ]}^{H} ) & B [ c ] ( c = {c}^{*} ) \\ \frac{1}{{β}^{θ}} B [ c ] & ( otherwise )\end{matrix} . \qquad [ Math . 59 ]$$

4. (canceled)

5. A computer implemented method for generating a reverberation prediction filter G[t] used at a time point t from an observation signal x[t] at the time point t, comprising:
determining a switch c* according to the following expression:
z[t,c]←x[t]-G[c]^{H}\hat{x}[t] [Math. 60]
(where L is a filter length, Δ is a prediction delay, and \hat{ }x[t]=[x[t−Δ]^{T}, . . . , x[t−Δ-L+1]^{T}]^{T}), C being the number of reverberation prediction filters, G[c] (where c=1, . . . , and C) being a reverberation prediction filter, p being a constant satisfying 0<p≤2, β being a constant satisfying 0<β≤1, and θ being a constant satisfying 0≤θ≤1, and
c*←argmin{∥z[t,c]∥2/2|c=1, . . . ,C} [Math. 61]
setting a reverberation prediction filter G[c*] calculated according to the following expression as the reverberation prediction filter G[t]:
$$w [ {c}^{*} ] ← \frac{p}{2} {( {‖ z [ t , {c}^{*} ] ‖}_{2} )}^{- 2 + p} \qquad [ Math . 62 ]$$
$$ψ ← \frac{B [ {c}^{*} ] \hat{x} [ t ]}{1 / w [ {c}^{*} ] + {\hat{x} [ t ]}^{H} B [ {c}^{*} ] \hat{x} [ t ]} \qquad [ Math . 63 ]$$
$$G [ {c}^{*} ] ← G [ {c}^{*} ] + ψ {z [ t , {c}^{*} ]}^{H} ; \qquad [ Math . 64 ]$$
and
updating a matrix B[c] according to the following expression:
$$B [ c ] ← \{ \begin{matrix}\frac{1}{β} ( I - ψ {\hat{x} [ t ]}^{H} ) & B [ c ] ( c = {c}^{*} ) \\ \frac{1}{{β}^{θ}} B [ c ] & ( otherwise )\end{matrix} . \qquad [ Math . 65 ]$$

6. (canceled)

7. The filter generation device according to claim 1, the processor further configured to execute operations comprising:
receiving, from one or more microphones, an observation signal x[t+1] at a time point after the time point t;
generating a reverberation prediction filter G[t+1]; and
generating audio signals by removing reverberation from the observation signal using the generated reverberation prediction filter G[t+1].

8. The filter generation device according to claim 1, wherein the reverberation prediction filter G[t] is based on processing online weighted prediction error.

9. The filter generation device according to claim 3, the processor further configured to execute operations comprising:
receiving, from one or more microphones, an observation signal x[t+1] at a time point after the time point t;
generating a reverberation prediction filter G[t+1]; and
generating audio signals by removing reverberation from the observation signal using the generated reverberation prediction filter G[t+1].

10. The filter generation device according to claim 3, wherein the reverberation prediction filter G[t] is based on processing online weighted prediction error.

11. The computer implemented method according to claim 5, further comprising:
receiving, from one or more microphones, an observation signal x[t+1] at a time point after the time point t;
generating a reverberation prediction filter G[t+1]; and
generating audio signals by removing reverberation from the observation signal using the generated reverberation prediction filter G[t+1].

12. The computer implemented method according to claim 5, wherein the reverberation prediction filter G[t] is based on processing online weighted prediction error.
